(19) United States
(12) Patent Application Publication
(10) Pub. No.: US 2007/0096553 A1
(43) Pub. Date: May 3, 2007

(54) Hydraulic unit for slip-controlled braking systems

(75) Inventors: Gabriele May, Offenbach (DE); Albrecht Otto, Schoneck (DE); Dieter Dinkel, Schwalbach (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/562,082

(22) PCT Filed: Jun. 2, 2004
(86) PCT No.: PCT/EP04/50982

§ 371 Date: Dec. 23, 2005

(30) Foreign Application Priority Data
Jun. 26, 2003 (DE) 103 28 808.2
Aug. 29, 2003 (DE) 10339882.1

(51) Int. Cl. B60T 8/36

(52) U.S. Cl. 303/119.3

(57) ABSTRACT

Disclosed is a hydraulic unit including an accommodating member having a first housing surface. The first housing surface has valve accommodating bores (X1-X4) in several valve rows (X, Y, Z), several inlet valves are arranged in a first valve row (X),several outlet valves are arranged in a second valve row (Y), and at least one separating valve is arranged in a third valve row (Z). The third valve row (Z) is arranged between the first and the second valve row (X, Y) in order to permit channel connections to a pump accommodating bore (5) which are as short as possible.

### BACKGROUND OF THE INVENTION

The present invention relates to a hydraulic unit for slip-controlled brake systems including an accommodating member having several rows of valve openings.

WO 99/25594 discloses a hydraulic unit for a slip-controlled brake system having a block-shaped accommodating member which comprises side by side in a first and a second valve row a total of eight valve accommodating bores, wherein electromagnetically operable inlet and outlet valves are inserted. Next to the two valve rows is a pump accommodating bore, two parallel accumulator accommodating bores, and a third valve row which receives in several valve accommodating bores exclusively the separating valves and electric change-over valves required for traction control and driving stability control.

The above arrangement of the valve rows necessitates relatively long channels in order to connect the brake pressure generator connections that are arranged laterally relative to the first valve row to the pump accommodating bore by way of the third valve row.

### SUMMARY OF THE INVENTION

In view of the above, an object of the invention is to improve a hydraulic unit of the indicated type by simple means in such a fashion that, while maintaining a construction as compact as possible, the above-mentioned drawback is avoided, with the aim of achieving a suction-optimized and noise-optimized design of the suction channel required for the pump.

According to the invention, this object is achieved for a hydraulic unit of the type mentioned hereinabove by using an accommodating member having a first housing surface and a second housing surface, wherein the first housing surface includes several valve accommodating bores in several valve rows, several inlet valves arranged in a first valve row, several outlet valves arranged in a second valve row, and at least one separating valve is arranged in a third valve row, the second housing surface accommodates at least one of a brake pressure generator and one wheel brake connection, wherein the third valve row is arranged between the first and the second valve row.

### BRIEF DESCRIPTION OF THE DRAWINGS

Further features, advantages and possible applications of the invention can be taken in the following from the description of an embodiment making reference to the accompanying drawings.

In the drawings:

FIG. 1 is a first three-dimensional representation of a total view of the subject matter of the invention with a top view of the valve rows in the first housing surface;

FIG. 2 is a perspective view of the accommodating member of FIG. 1 in a view turned by 180 degrees about the pump axis in order to illustrate all accommodating bores and pressure fluid channels in the accommodating member;

FIG. 3 is a detailed drawing of FIG. 2 for explaining the suction path of the pump between the accumulator accommodating bore and the third valve row;

FIG. 4 is a detailed drawing of FIG. 2 for explaining the pump pressure side for the purpose of a hydraulic connection between the pump accommodating bore and the first valve row;

FIG. 5 is another detailed drawing of FIG. 2 for illustrating the duct connection of the wheel brake circuits with the first and the second valve row and the pressure sensor row;

FIG. 6 is a partial view of the accommodating member of FIG. 2 with a representation of the wheel pressure channels provided between the second valve row by way of the accumulator accommodating bores to the first valve row;

FIG. 7 is the spatial representation of additional guiding, fixing and leakage bores in the accommodating member.

### DETAILED DESCRIPTION OF THE DRAWINGS

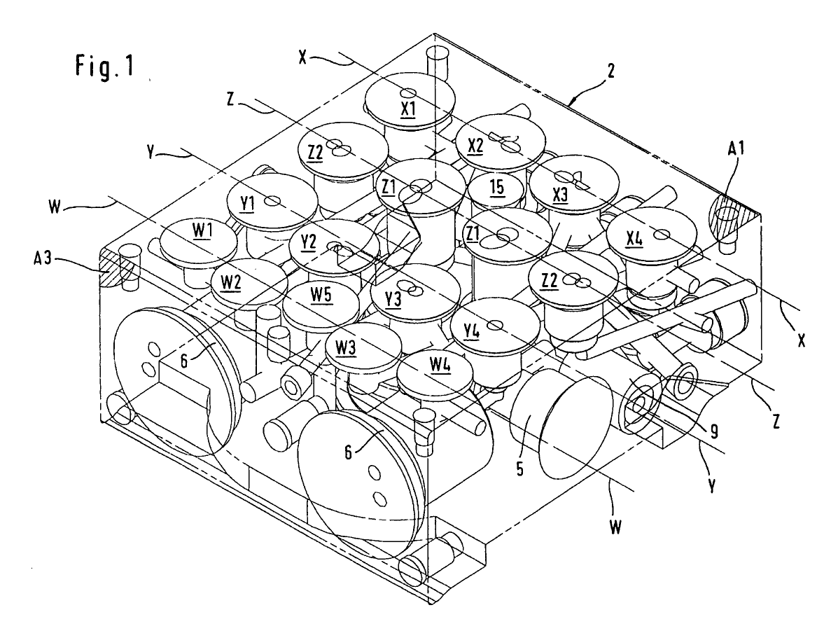

FIG. 1 shows a perspective view of a hydraulic unit for a slip-controlled, dual-circuit motor vehicle brake system, with a block-shaped accommodating member 2 which accommodates inlet and outlet valves in respectively four valve accommodating bores X1-X4, Y1-Y4 of a first and a second valve row X, Y, said bores opening as blind-end bores into a first housing surface A1 of the accommodating member 2 up to a first housing plane. Further, the block-shaped accommodating member 2 is penetrated in another housing plane by two diametrically aligned pump accommodating bores 5 which exhibit a slight axle shift for accommodating two axially offset pump pistons. Irrespective of whether the accommodating member 2 comprises only one single pump accommodating bore 5 for a pump which is not axially offset, or two pump accommodating bores 5 for the axially offset pump used as an example, each pump accommodating bore 5 points transversely to the direction of the valve accommodating bores X1-X4, Y1-Y4 opening into the accommodating member 2. Although the pump accommodating bore 5 is offset from the first housing plane of the valve rows X, Y, Z, it is disposed between the axes of the valve accommodating bores Y1-Y4, Z1-Z4 of the second and third valve row Y, Z being aligned vertically to the first housing surface A1.

Two parallel arranged accumulator accommodating bores 6 open into the accommodating member 2 in a third housing surface A3 which is positioned preferably at right angles to the first housing surface A1, said bores 6 extending in a transverse position to the valve accommodating bores Y1-Y4 until shortly before the second valve row Y and the pump accommodating bores 5. The depth of the accumulator accommodating bores 6 is consequently smaller in size than the horizontal distance between the second valve row Y and the third housing surface A3 so that the connection between the third valve row Y and the accumulator accommodating bores 9 takes place by way of especially short wheel pressure channels 7. Spring-loaded pistons being closed by covers are inserted into the accumulator accommodating bores 6.

Electromagnetically operable outlet valves, being normally closed in their basic position, are arranged in the valve accommodating bores Y1-Y4 of the second valve row Y. The valve accommodating bores Y1-Y4 of the second valve row Y are arranged in a particularly compact fashion between the two accumulator accommodating bores 6 and the pump accommodating bores 5.

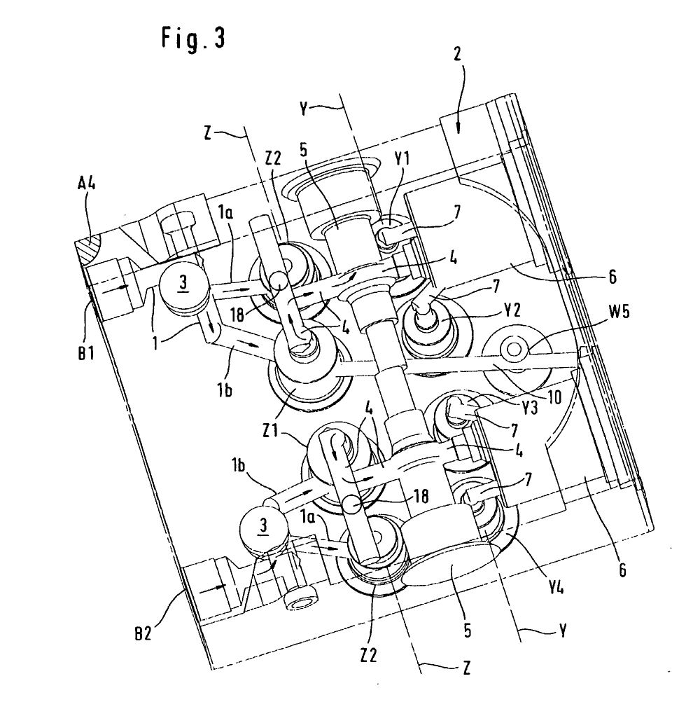

Next to the second valve row Y above the accumulator accommodating bores 6, five short pressure sensor accumulator bores W1-W5 of a pressure sensor row W open into the first housing surface A1 of the accommodating member 2, and the four pressure sensor accommodating bores W1-W4 in which the wheel brake pressure in all four wheel brakes is sensed are connected by way of four wheel pressure channels 12 to the valve accommodating bores X1-X4 of the first valve row X. The fifth pressure sensor accommodating bore W5 arranged between the four pressure sensor accommodating bores W1-W4 is connected to the brake pressure generator connection B1 (see FIG. 3) by way of a pressure sensor channel 10 and by way of the valve accommodating bore Z1 receiving the change-over valve in order to sense the actuating pressure in the pressure piston circuit.

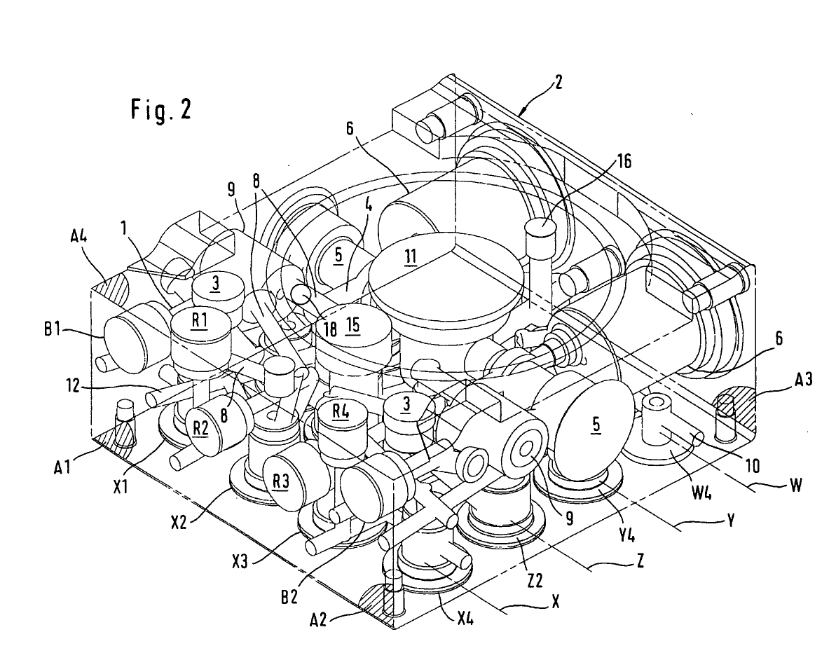

As can be seen in FIG. 2, two brake pressure generator connections B1, B2 and the two wheel brake connections R2, R3 open close to the outside edges of the block-shaped accommodating member 2 into the second housing surface A2, which is due to the dual-circuit configuration of the brake system. As the brake system is used in a multi-track motor vehicle braked on four wheels, two additional wheel brake connections R1, R4 are arranged in an easy-to-mount fashion on the top surface of the accommodating member 2 being designated as housing surface A4.

To establish a hydraulic connection between a brake pressure generator connection B1 or B2, respectively, and the wheel brake connections R1, R2 of the first brake circuit or to the wheel brake connections R3, R4, respectively, there is need for several channels which connect the valve accommodating bores, the pump accommodating bores and the accumulator accommodating bores and are mainly manufactured by skillful drilling operations within the accommodating member 2 exactly as the valve accommodating bores, the pump accommodating bores and the accumulator accommodating bores.

According to FIG. 2, a motor accommodating bore 11 is further directed to the pump accommodating bores 5 at a vertical distance from the first housing surface A1, and bore 11 does not only serve for the attachment of an electric motor that actuates the pump pistons in the pump accommodating bore 5 but also comprises a crank or eccentric drive. Except for the bores necessary for the wheel brake connections R1, R4, the motor accommodating bore 11 is consequently arranged centrically at the fourth housing surface A4 that is opposite to the first housing surface A1.

As can already be seen in FIG. 1, FIG. 3 likewise discloses the short blind-end bores of the valve accommodating bore Z1-Z4, Y1-Y4, with each bottom of the valve accommodating bores Y1-Y4 being connected to respectively one portion of a return channel 7 that leads to the accumulator accommodating bore 6. To maintain an extremely compact type of construction, each return channel 7 is therefore arranged as an angular channel laterally to the short portion of the suction channel 4.

The third valve row Z is arranged between the first and the second valve row X, Y in order to render the function of the accommodating member 2 as optimal as possible in view of the object of the invention to be achieved. The first valve row X opens into the accommodating member 2 directly beside the brake pressure generator connections and wheel brake connections B1, B2, R1-R4, while the arrangement of the second valve row Y between the third valve row Z and the accumulator accommodating bore 6 allows extremely short return channels 7.

To illustrate the construction of the hydraulic unit, essential features of the arrangement of bores in the block for the areas of the accommodating member 2, which can be seen clearly in FIG. 1 and 2 only to a partial extent, have been emphasized and described separately in the following by making reference to FIGS. 3 to 7.

FIG. 3 shows that each brake pressure generator connection B1, B2 is connected by way of a first portion la of a supply channel 1 to the valve accommodating bore Z2 in the third valve row Z in which the separating valve is received, the channel opening as an oblique channel into the valve accommodating bore Z1 in a radial or, optionally, even a tangential fashion.

Connected to each supply channel 1 between the brake pressure generator connection B1, B2 and the third valve row Z is a bore 3 for a pulsation damper which opens into the fourth housing surface A4 that is opposite to the first housing surface A1. The first portion la is connected in each case by way of the supply channel 1 to a second portion 1b which leads to another valve accommodating bore Z1 in the third valve row Z, into which the electrically operable change-over valve is inserted. The length of the relatively short supply channel 1 and the portions 1a, 1b branched at the supply channel renders the construction extremely compact both due to the short distance of the third valve row Z from the first valve row X and the short distance of the first valve row X from the brake pressure generator connection B1, B2, so that the hydraulic unit can be machined with minimum chip removal.

At the additional valve accommodating bore Z1 of the third valve row Z which receives the change-over valve, a short suction channel 4 is connected to the bottom of the valve accommodating bore Z1 and leads to the pump accommodating bore 5. The length of the suction channel 4 is favorably determined by the very small distance between the third valve row Z and the pump accommodating bore 5. The portion of the suction channel 4 that extends above the third valve row Z is drilled into the lateral surface of the accommodating member 2 in parallel to the direction of the port of the pump accommodating bore 5 and closed with a ball in a deepest possible way roughly at the level of the second portion of the suction channel 4 that penetrates the pump accommodating bore 5 in order to reduce the absorptive volume. The ball-shaped closure element 18 is furthermore used to prevent a hydraulic short-circuit between the pressure damping chamber 9 and the suction channel 4 because the blind-end bore for the suction channel 4 extends favorably through the blind-end bore of the pressure damping chamber 9, what simplifies the removal of metal from the accommodating member 2 by cutting.

A single drilling operation is needed for the second portion of the suction channel 4 to extend both through the bottom of the accumulator accommodating bore 6 and transversely through the pump accommodating bore 5. The suction channel 4 thus traverses in each case the area of the pump remote from the outside ends of the pump accommodating bore 5 and positioned close to the motor accommodating bore 11.

A non-return valve opening in the direction of the pump accommodating bore 5 is inserted into the portion of the suction channel 4 which extends between the pump accommodating bore 5 and the accumulator accommodating bore 6. Further, two short return channels 7 open for each brake circuit close to the suction channel 4 into the bottom of the accumulator accommodating bore 6, the channels being angled off in a downward direction and connected to two valve accommodating bores Y2 receiving the outlet valves in the second valve row Y.

Corresponding to the illustration in FIG. 3, the valve accommodating bores Y1, Y2 or Y3, Y4, respectively, are thus arranged in an especially compact manner below the accumulator accommodating bore 6 in the accommodating member 2. Thus, the second valve row Y is in direct vicinity of the accumulator accommodating bore 6 so that shortest possible return channels 7 and short suction channels 4 lead to the accumulator accommodating bores 6, whereby the evacuation, the filling and the efficiency of the hydraulic unit is lastingly improved.

Besides, FIG. 3 shows the extremely simple connection of the brake pressure generator connection B1 to the pressure sensor accommodating bore W5, to what end the pressure sensor channel 10 extends as an oblique channel transversely through the pressure sensor accommodating bore W5 and between the valve accommodating bores Y2, Y3 into the valve accommodating bore Z1 which is connected to the brake pressure generator connection B1 by way of the supply channel 1.

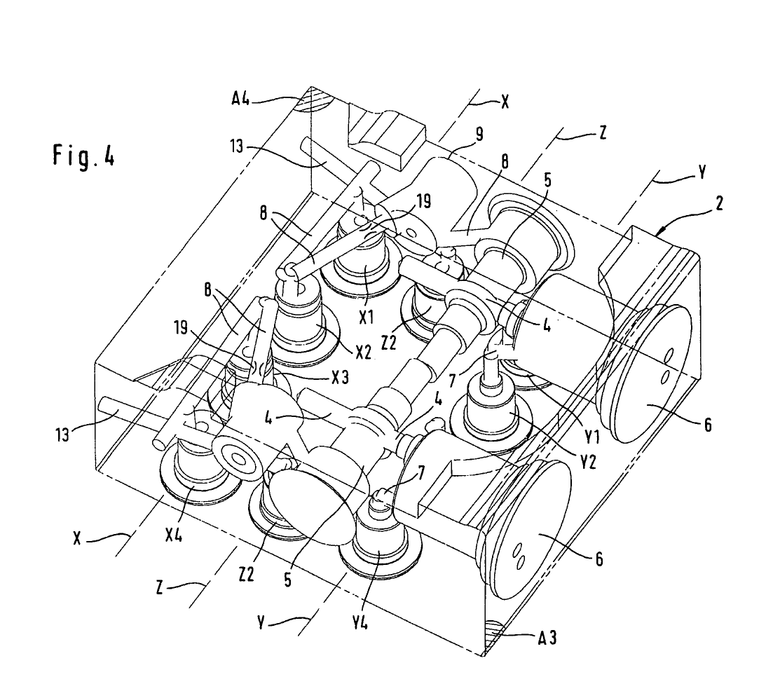

In addition to FIG. 3, FIG. 4 shows the channel routing on the pump pressure side, to what end a pressure channel 8 opens into the pump accommodating bore 5 in a radial or tangential manner for each circuit remote from the suction channel 4 and is connected by way of a pressure damping chamber 9 to the valve accommodating bores X1, X2 or X3, X4, respectively, of the first valve row X in which the inlet valves are received, and to the valve accommodating bore Z2 provided for the separating valve. Both pressure damping chambers 9 are arranged between the pump accommodating bores 5 and the valve accommodating bores X1-X4 of the first valve row X in the accommodating member 2 in a fashion that is extremely favorable under aspects of manufacture and flow. To this effect, the pressure damping chambers 9 are machined as blind-end bores in parallel to the pump accommodating bores 5 and bored through in the direction of the first valve row X at the bottom of the blind-end bore for connecting to the first valve row X. For the connection of the valve accommodating bore Z2 provided for the separating valve, the pressure channel 8 leads as a blind-end bore above the bottoms of the valve accommodating bores X1, X2 or X3, X4, respectively, in the direction of the axis of the first valve row X to the outside surface of the accommodating member 2, into which also the pump accommodating bore 5 and the pressure damping chamber 9 open, and is intersected by an oblique channel 13 which finally connects the pressure channel 8 to the bottom of the valve accommodating bore Z2.

The short portion of the pressure channel 8 required between the pump accommodating bore 5 and the pressure damping chamber 9 is provided by a bore which penetrates the wall of the pump accommodating bore 5 because a drilling operation is carried out into the outside end of the pump accommodating bore 5 transversely in the direction of the pressure damping chamber 9 so that, in addition to the closure of the pump accommodating bore 5 at the outside surface of the accommodating member 2, the pressure channel 8 is closed towards the atmosphere. This obviates the need for a complicated separate closure of the pressure channel 8 with a ball.

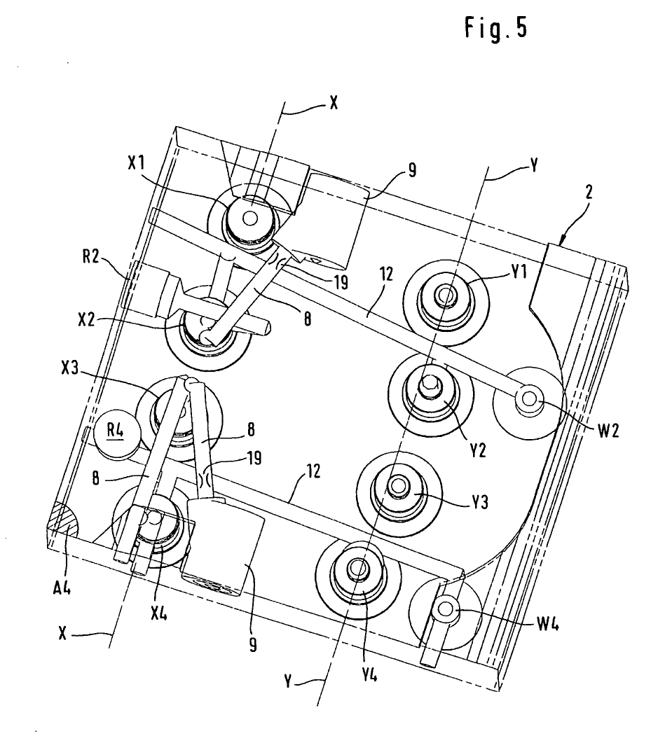

FIG. 5 shows the valve accommodating bores Y1-Y4 and two of four wheel pressure channels 12 which, starting from the second housing surface A2, traverse as blind-end bores the first valve row X and the second valve row Y up to the associated pressure sensor accommodating bores W2, W4. Thus, the wheel pressure channels 12 lead past the third valve row Z (not shown) to the walls of the valve accommodating bores X2 or X4, respectively, and to the walls of the valve accommodating bores Y2 or Y4, respectively, in the second valve row Y and, depending on the switching position of the inlet valves, are in connection to the wheel brake connections R2 or R4, respectively, connected to the bottoms of the valve accommodating bores X2 or X4, respectively.

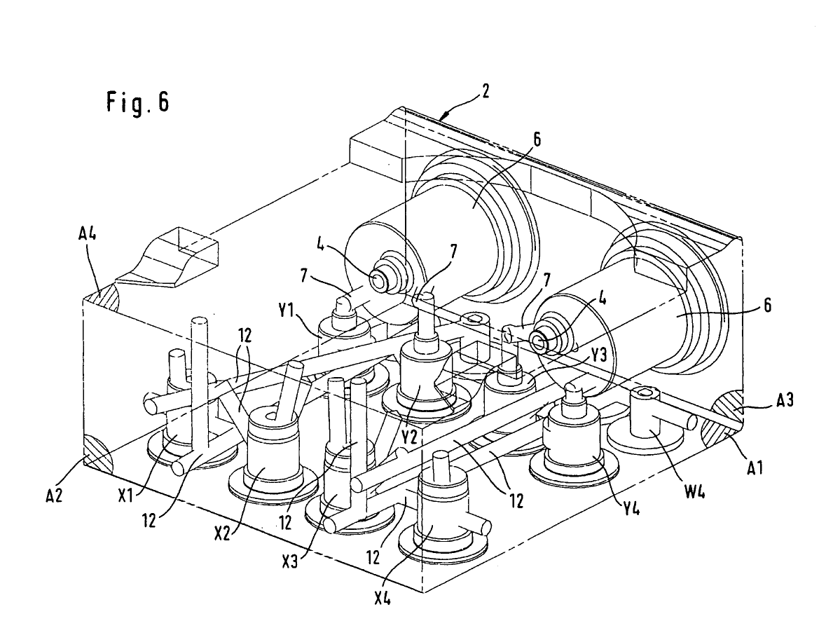

Eventually, FIG. 6 illustrates the spatial arrangement of all four wheel pressure channels 12 in the accommodating member 2 which are necessary for the connection of the valve accommodating bores X1-X4, Y1-Y4, which open in sections as oblique channels from the first housing surface A1 into the walls of the valve accommodating bores X2, X3 with respect to the valve accommodating bores X2, X3 being centrically positioned in the valve row X, or which open in sections as horizontal channels into the walls of the valve accommodating bores X1, X4 with respect to the two valve accommodating bores X1, X4 that lie outwards in the valve row X. Likewise the valve accommodating bores Y2 or Y3, respectively, are connected to the valve accommodating bores X2 or X3, respectively, by means of laterally transversely opening connection in each case by way of a pair of horizontally extending wheel pressure channels 12. At the bottoms of the valve accommodating bores Y1 to Y4, the four short return channels 7 can be recognized as angular channels that lead to the accumulator accommodating bores 6.

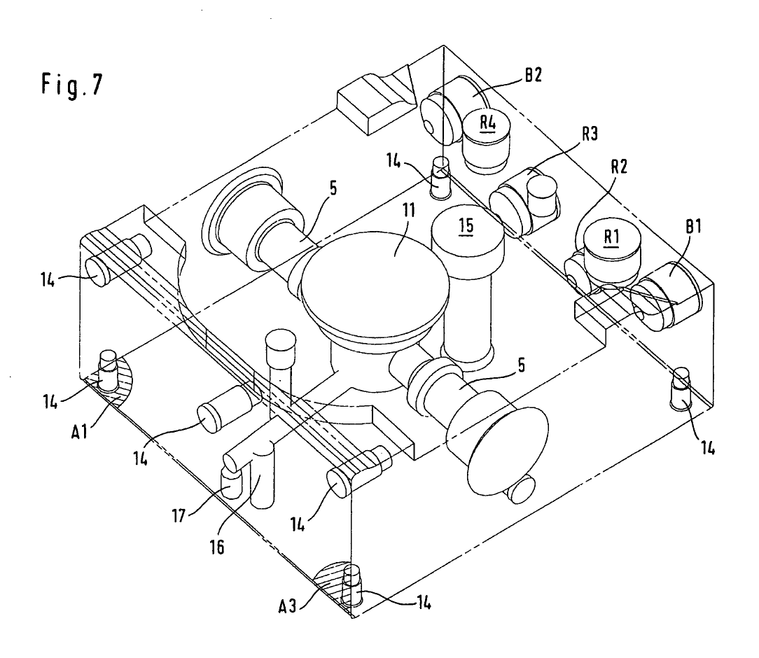

Finally, FIG. 7 illustrates the position of the fastening thread at the first and third housing surface A1, A3 in order to be able to connect the accommodating member 2, on the one hand, at the first housing surface A1 to a control device that activates the valves in the valve rows X, Y, Z and the motor, while, on the other hand, also being able to connect the accommodating member 2 e.g. at its third housing surface A3 to the vehicle. Further, a cable duct 15 traverses the accommodating member 2 in parallel to the motor accommodating bore 11 in order to provide the electric connection between the diametrically aligned control device and the electric motor by way of the cable duct 15. In addition, the motor accommodating bore 11 includes a leakage channel 16 that projects from the first housing surface Al so that pump leakage that might develop can be discharged. Eventually, it is also possible to provide a centering and/or coding element 17 for the control device at the accommodating member 2 which is likewise disposed at the first housing surface A1.

To sum up, the mode of function of the hydraulic unit for a motor vehicle brake system, which has already been described in its essential elements, shall now be explained making reference to a synopsis of FIGS. 3 to 6.

Associated with the first brake circuit is the brake pressure generator connection B1 (see FIGS. 2, 3) which is normally connected to the wheel brake connections R1, R2 by means of the supply channel 1 through the valve accommodating bore Z2 in the third valve row Z that accommodates the separating valve and, subsequently, through the valve accommodating bores X1, X2 of the first valve row (see FIGS. 4, 5) being arranged directly adjacent to the third valve row Z. Thus, an unimpeded connection exists in the slip-free brake operation through the separating valve in the valve accommodating bore Z2 that is open in its basic position to the normally open inlet valves in the two valve accommodating bores X1, X2 which are directly connected to the wheel brake connections R1, R2 of the first brake circuit through the channel portions of the wheel pressure channels 12.

For brake slip control, there is e.g. for the wheel brake connected to the wheel brake connection R2 (see FIG. 5) in a pressure reduction phase within the first brake circuit a pressure fluid connection between the valve accommodating bores X2 through the one portion of the wheel pressure channel 12 and the opened outlet valve in the valve accommodating bore Y2 so that superfluous brake pressure volume propagates from there through the return channel 7 (see FIG. 6) succeeding at the bottom of the valve accommodating bore Y2 into the first accumulator accommodating bore 7 of the first brake circuit, from which, for the purpose of new brake pressure buildup in the wheel brake R2 (see FIG. 4), the pressure fluid stored in the accumulator accommodating bore 7 is supplied through the short portion of the suction channel 4 (and the non-return valve disposed therein) per brake circuit from a pump piston in the associated pump accommodating bore 5 to the pressure channel 8, to the pressure damping chamber 9 and further, through the portion of the pressure channel 8 that extends obliquely to the first valve row X, to the valve accommodating bore X2 in which the inlet valve remains in its open basic position for a new brake pressure buildup. As the outlet valve of the valve accommodating bore Y2 will then remain in its closed position, escape of the pressure fluid out of the valve accommodating bore X2 through the valve accommodating bore Y2 into the accumulator bore 6 is prevented. If, however, the wheel brake pressure in the wheel brake R2 shall be kept constant, then both the inlet valve and outlet valve associated with the wheel brake R2 will remain in their closed position.

In the first brake circuit which has been described already by way of example, the separating valve inserted into the valve accommodating bore Z2 of the third valve row Z is closed electromagnetically for driving dynamics control, while the change-over valve arranged in the valve accommodating bore Z1 is opened (see FIG. 3) so that pressure fluid propagates by way of the supply channel 1 of the brake pressure generator connection B1 that opens laterally into the valve accommodating bore Z1 through the bore 3 of the pulsation damper exclusively by way of the second portion 1b of the supply channel 1 to a first potion of the suction channel 4 disposed at the bottom of the valve accommodating bore Z1, thus establishing a direct connection to the pump accommodating bore 5 on the shortest way. The pump piston inserted into the pump accommodating bore 5 subsequently supplies the pressure fluid, which enters through the first portion of the suction channel 4, further through the pump suction and pump pressure valve inserted into the pump accommodating bore 5 into the pressure channel 8 (see FIG. 4) and from there through the pressure damping chamber 9 and an orifice 19 inserted into the pressure channel 8 to the valve accommodating bores X1, X2 which, depending on the pressure control cycle that prevails, are either opened or closed by the inlet valves in the direction of the wheel brake connections R1, R2.

Even if the traction slip control instead of the driving dynamics control commences, the separating valve in the valve accommodating bore Z2 (see FIG. 3) remains closed within the limits of the allowable system pressure so that pressure fluid cannot escape on the pump pressure side through the separating valve to the brake pressure generator connection B1. The separating valve is forced to open hydraulically only when the allowable system pressure is exceeded.

The exemplary description of the brake pressure control is, of course, not limited to the connection of the wheel brake to the wheel brake connection R2 or to the associated brake circuit.

It can be seen from the three-dimensional illustration of the hydraulic unit of the invention that a flow-optimized pressure fluid channel system is achieved between the individual valve rows X, Y, Z by means of straight and transverse bores, which system is easy to realize under aspects of manufacturing technique.

Due to the position of the third valve row Z chosen, a particularly short, low-resistance suction channel 4 is favorably achieved for each brake circuit, which is quick and easy to bleed and fill. In addition, the arrangement of the three valve rows X, Y, Z in the accommodating member 2 allows the pressure fluid to propagate quickly and reliably through the brake pressure generator connection B1 or B2, respectively, in the shortest way both to the first valve row X and to the third valve row Z.

The previous description relating to the first brake circuit similarly applies to the design and the function of the elements required for the second brake circuit which are arranged mirror-symmetrically with respect to the elements of the first brake circuit in the accommodating member 2.

### LIST OF REFERENCE NUMERALS

1 supply channel
1a first portion
1b second portion
2 accommodating member
3 bore
4 suction channel
5 pump accommodating bore
6 accumulator accommodating bore
7 return channel
8 pressure channel
9 pressure damping chamber
10 pressure accumulator channel
11 motor accommodating bore
12 wheel pressure channel
13 oblique channel
14 fastening thread
15 cable duct
16 leakage channel
17 centering/coding element
18 closure element
19 orifice
X1 valve accommodating bore
X2 valve accommodating bore
X3 valve accommodating bore
X4 valve accommodating bore
Y1 valve accommodating bore
Y2 valve accommodating bore
Y3 valve accommodating bore
Y4 valve accommodating bore
Z1 valve accommodating bore
Z2 valve accommodating bore
Z3 valve accommodating bore
Z4 valve accommodating bore
W1 pressure sensor accommodating bore
W2 pressure sensor accommodating bore
W3 pressure sensor accommodating bore
W4 pressure sensor accommodating bore
W5 pressure sensor accommodating bore
X valve row
Y valve row
Z valve row
B1 brake pressure generator connection
B2 brake pressure generator connection
A1 housing surface
A2 housing surface
A3 housing surface
A4 housing surface
R1 wheel brake connection
R2 wheel brake connection
R3 wheel brake connection
R4 wheel brake connection

1-13. (canceled)

14. A hydraulic unit for slip-controlled brake systems, the hydraulic unit comprising:
an accommodating member having a first housing surface and a second housing surface, wherein the first housing surface includes several valve accommodating bores in several valve rows, several inlet valves arranged in a first valve row, several outlet valves arranged in a second valve row, and at least one separating valve is arranged in a third valve row, the second housing surface accommodates at least one of a brake pressure generator and one wheel brake connection, wherein the third valve row (Z) is arranged between the first and the second valve row (X, Y);
a pump accommodating bore arranged in the accommodating member and pointing transversely to a direction the valve accommodating bores open into the accommodating member;
a motor accommodating bore arranged in the accommodating member and pointing to the pump accommodating bore;
an accumulator accommodating bore opening into the accommodating member and arranged adjacent to the second valve row housing the outlet valves, wherein the accumulator includes several channels which connect the valve accommodating bores, the pump accommodating bores and the accumulator accommodating bores and are able to establish a hydraulic connection between the brake pressure generator connection and the wheel brake connection.

15. The device according to claim 14, wherein the first valve row opens directly beside the brake pressure generator and wheel brake connections into the accommodating member, while the second valve row opens between the third valve row and the accumulator accommodating bore into the accommodating member.

16. The device according to claim 14, wherein the brake pressure generator is connected by way of a first portion of a supply channel to the valve accommodating bore of the third valve row that accommodates the separating valve, opening as an oblique channel radially or tangentially into the valve accommodating bore.

17. The device according to claim 14, wherein a bore for a pulsation damper opens into the accommodating member between the brake pressure generator connection and the third valve row, and the bore is connected to the supply channel and aligned opposite to the first housing surface in the accommodating member.

18. The device according to claim 14, wherein the supply channel has a second portion which leads to an additional valve accommodating bore in the third valve row into which an electrically operable change-over valve is inserted.

19. The device according to claim 18, wherein a length of the first portion and the second portion of the supply channel in the accommodating member is defined by the distance of the third valve row from the brake pressure generator connection.

20. The device according to claim 18, wherein a suction channel is connected to the additional valve accommodating bore of the third valve row in which the change-over valve is received, the suction channel in the accommodating member leading preferably as an angular channel to the pump accommodating bore.

21. The device according to claim 20, wherein a length of the suction channel is defined by the distance of the third valve row from the pump accommodating bore.

22. The device according to claim 20, wherein the pump accommodating bore (is penetrated by the suction channel in the direction of an accumulator accommodating bore and the suction channel opens into the bottom of the accumulator accommodating bore.

23. The device according to claim 22, wherein a non-return valve opens in the direction of the pump accommodating bore is inserted into the portion of the suction channel which is positioned between the pump accommodating bore and the accumulator accommodating bore.

24. The device according to claim 22, wherein the opening into the bottom of the accumulator accommodating bore is a return channel which is connected to at least one valve accommodating bore accommodating the outlet valves in the second valve row and opening into the accommodating member between the accumulator and pump accommodating bores.

25. The device according to claim 20, wherein remote from the suction channel, a pressure channel opens radially or tangentially into the pump accommodating bore, the pressure channel being connected by way of a pressure damping chamber to the valve accommodating bores of the first valve row in which the inlet valves are received, the pressure damping chamber is arranged in the accommodating member between the pump accommodating bore and the valve accommodating bores of the first valve row.

26. The device according to claim 14, wherein close to the second valve row, several pressure sensor accommodating bores of a pressure sensor row open into the first housing surface of the accommodating member which, by way of several pressure sensor channels is connected to wheel pressure channels, are connected to the valve accommodating bores of the first valve row and the valve accommodating bore of the third valve row in which the change-over valve is received.
